(19) United States
(12) Patent Application Publication
(10) Pub. No.: US 2018/0376121 A1
(43) Pub. Date: Dec. 27, 2018

(54) METHOD AND ELECTRONIC DEVICE FOR DISPLAYING PANORAMIC IMAGE

(71) Applicant: Acer Incorporated, New Taipei City (TW)

(72) Inventors: Yu-Xiang Wang, New Taipei City (TW); Chung-Hsien Lee, New Taipei City (TW)

(73) Assignee: Acer Incorporated, New Taipei City (TW)

(21) Appl. No.: 15/846,210

(22) Filed: Dec. 19, 2017

(30) Foreign Application Priority Data
Jun. 22, 2017 (TW) 106120868

(51) Int. Cl. H04N 13/00; H04N 5/232; G06F 3/0481; G06K 9/00; G06F 3/0484; G06F 3/0488

(52) U.S. Cl. CPC H04N 13/0014; H04N 5/23238; G06F 3/04883; G06K 9/00255; G06F 3/04842; G06F 3/04817

(57) ABSTRACT

A method and an electronic device for displaying a panoramic image are proposed. The method is applicable to an electronic device having a screen and an input device and includes the following steps. The panoramic image is obtained, and human face recognition is performed on the panoramic image so as to identify key human faces therefrom. A preset region of the panoramic image along with icons associated with all key human faces are displayed on a display frame of the screen. In response to a selecting operation performed by the user through the input device on a first icon being detected, a first region of the panoramic image in which a first key human face corresponding to the first icon is located is displayed on the display frame.

### CROSS-REFERENCE TO RELATED APPLICATION

This application claims the priority benefit of Taiwan application serial no. 106120868, filed on Jun. 22, 2017. The entirety of the above-mentioned patent application is hereby incorporated by reference herein and made a part of this specification.

### TECHNICAL FIELD

The disclosure relates to a technique for displaying a panoramic image.

### BACKGROUND

With development in technology, various smart image capturing devices, such as tablet computers, personal digital assistants and smart phones, have become indispensable tools for people nowadays. Camera lenses equipped in high-end smart image capturing devices provide same or better specifications than those of traditional consumer cameras, and some even provide near-equivalent pixel qualities to those of digital single lens reflex cameras.

For example, a panoramic image with all surrounding details captured by a 360-degree camera would give a viewer an immersive experience. However, the viewer would require some efforts to adjust his/her viewing angle of such image in order to search for certain main subjects.

### SUMMARY OF THE DISCLOSURE

Accordingly, a method and an electronic device for displaying a panoramic image are proposed in the disclosure, where the user would be able to view the panoramic image in an intuitive and speedy manner.

According to one of the exemplary embodiments, the method is applicable to an electronic device having a screen and an input device and includes the following steps. The panoramic image is obtained, and human face recognition is performed on the panoramic image so as to identify key human faces therefrom. A preset region of the panoramic image along with icons associated with all key human faces are displayed on a display frame of the screen. In response to a selecting operation performed by the user through the input device on a first icon being detected, a first region of the panoramic image, in which a first key human face corresponding to the first icon is located, is displayed on the display frame.

According to one of the exemplary embodiments, the electronic device includes a screen, an input device, a memory, and a processor, where the processor is coupled to the screen, the input device, and the memory. The screen is configured to provide a display frame. The input device is configured to detect operations performed on the electronic device. The memory is configured to store data. The processor is configured to obtain the panoramic image, perform human face recognition on the panoramic image so as to identify key human faces therefrom, display a preset region of the panoramic image and icons corresponding to the key human faces on the display frame of the screen, and in response to a selecting operation performed by the user through the input device on a first icon being detected, display a first region, in which a first key human face corresponding to the first icon is located, on the display frame.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic block diagram of an electronic device in accordance with one of the exemplary embodiments of the disclosure.

FIG. 2 illustrates a flowchart of a method for displaying a panoramic image in accordance with one of the exemplary embodiments in the disclosure.

FIG. 3A-FIG. 3B illustrate a scenario of displaying a panoramic image in accordance with one of exemplary embodiments of the disclosure.

FIG. 4A-FIG. 4B illustrate a scenario of displaying a panoramic image in accordance with one of exemplary embodiments of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

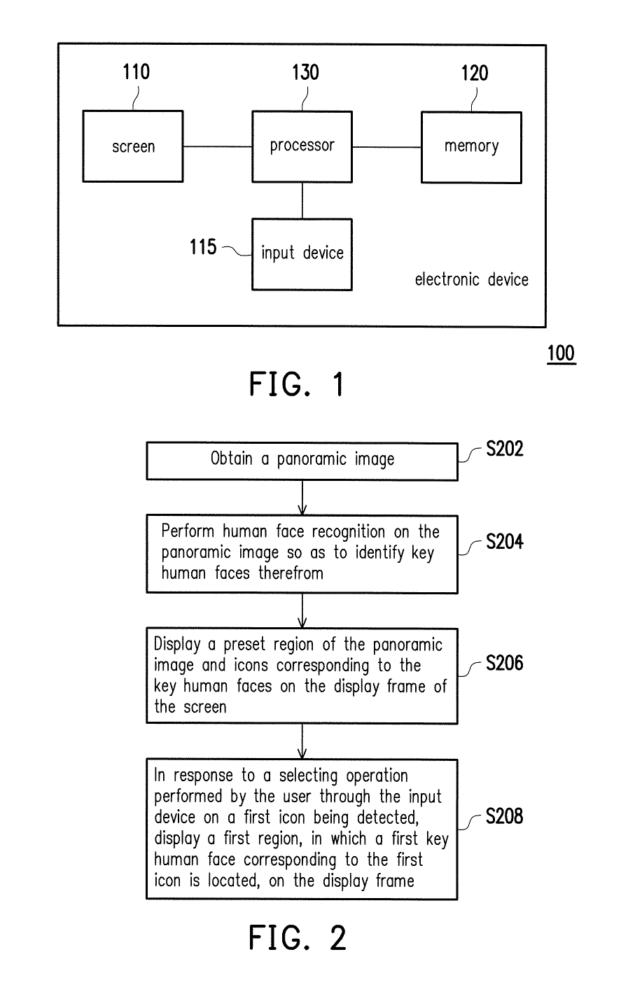

FIG. 1 illustrates a schematic block diagram of an electronic device in accordance with one of the exemplary embodiments of the disclosure. All components of the electronic device and their configurations are first introduced in FIG. 1. The functionalities of the components are disclosed in more detail in conjunction with FIG. 2.

Referring to FIG. 1, an electronic device 100 would include a screen 110, an input device 115, a memory 120, and a processor 130. In the present exemplary embodiment, the electronic device 100 may be a computer system, such as a person computer, a laptop computer, a smart phone, a tabular computer, a personal digital assistant (PDA), and display panoramic images obtained from other image capturing devices based on the proposed method. In another exemplary embodiment, the electronic device 100 may be an electronic device which is capable to capture panoramic images such as a digital camera, a digital camcorder, a single-lens reflex camera, a smart phone, a tabular computer, a PDA, and yet the disclosure is not limited thereto.

The screen 110 would be configured to provide display frames outputted by the electronic device 100 for the user to view. In the exemplary embodiment, the screen 110 may be, for example a liquid crystal display (LCD), a light-emitting diode (LED) display, a field emission display (FED), or other types of displays.

The input device 115 would be configured to provide the user to operate the electronic device 100 and may be a keyboard, a mouse, a stylus pen, a touch panel, a tracking ball, or other devices that are externally connected to or built-in in the electronic device 100. In an exemplary embodiment, the screen 110 and the input device 115 would be integrated as a touch screen such as a capacitive touch screen or a resistive touch screen and configured to receive touch operations of fingers, palms, or other objects by the user.

The memory 120 would be configured to store data and images and may one or a combination of a stationary or mobile random access memory (RAM), a read-only memory (ROM), a flash memory, a hard drive, other similar devices or integrated circuits.

The processor 130 would be coupled to the screen 110, the input device 115, and the memory 120 and configured to control the operation among the components of the electronic device 100. The processor 130 may be a central processing unit (CPU) or other programmable devices for general purpose or special purpose a microprocessor and a digital signal processor (DSP), a programmable controller, an application specific integrated circuit (ASIC), a programmable logic device (PLD), other similar devices or a combination of aforementioned devices. Once the processor 130 receives a panoramic image, it would perform the proposed method thereon.

FIG. 2 illustrates a flowchart of a method for displaying a panoramic image in accordance with one of the exemplary embodiments in the disclosure. The steps of FIG. 2 could be implemented by the electronic device 100 as illustrated in FIG. 1.

Referring to both FIG. 1 and FIG. 2, the processor 130 of the electronic device 100 would obtain a panoramic image (Step S202). Herein, the processor 130 may obtain the panoramic image from an image capturing module (not shown) of the electronic device 100 or from another image capturing device. The panoramic image may be a panoramic image or video with 180 degrees, 360 degrees, 720 degrees, and so forth.

Next, the processor 130 would perform human face recognition on the panoramic image so as to identify key human faces therefrom (Step S204). The processor 130 may identify all human faces from the panoramic image by leveraging human face recognition technology in computer vision and then select the key human faces according to, for example, size information and/or position information of each of the human faces.

In an exemplary embodiment, since main subjects are relatively closer to a camera lens in most photo-shooting scenarios, the processor 130 may sort all of the identified human faces by sizes, set the larger human faces as the key human faces, and set the smaller human faces as insignificant human faces for selecting the main subjects.

In an exemplary embodiment, the processor 130 may select the main subjects according to angle information and normal position information of the identified human faces with respect to the camera lens. For example, assume that the front of the camera is preset to 90 degrees. The human faces that are closer to 90 degrees are set as the key human faces, and the human faces that are more deviated from 90 degrees are set as the insignificant human faces.

Due to size restriction of the screen 110, the processor 130 would only be able to display a portion of the panoramic image, where such portion would be considered as a preset region and may be, for example, a front region of the camera lens. When any of the main subjects is located outside of the preset region, the user would not be able to know whether there exists such main subject or would spend time on searching for such main subject. Hence, the processor 130 may use the selected key human faces for guiding purposes by displaying a preset region of the panoramic image and icons corresponding to all the key human faces on the display frame of the screen 110 (Step S206). Each of the icons may be an interactive object in any shape and may display its corresponding key human face to guide the user about all key elements in the panoramic image. Moreover, each of the icons may be displayed at edges of the display frame so that the user would not be affected when viewing the panoramic image.

Next, the processor 130 would continuously detect a selecting operating performed by the user on any of the icons. In response to a selecting operation performed by the user through the input device 115 on a first icon being detected, the processor 130 would display a first region, in which a first key human face corresponding to the first icon is located, on the display frame (Step S208). That is, when the user selects the first icon, the display frame would be shifted from the preset region of the panoramic image to the first region in which the first key human face is located so that the user would be able to view the selected main subject in a speedy manner.

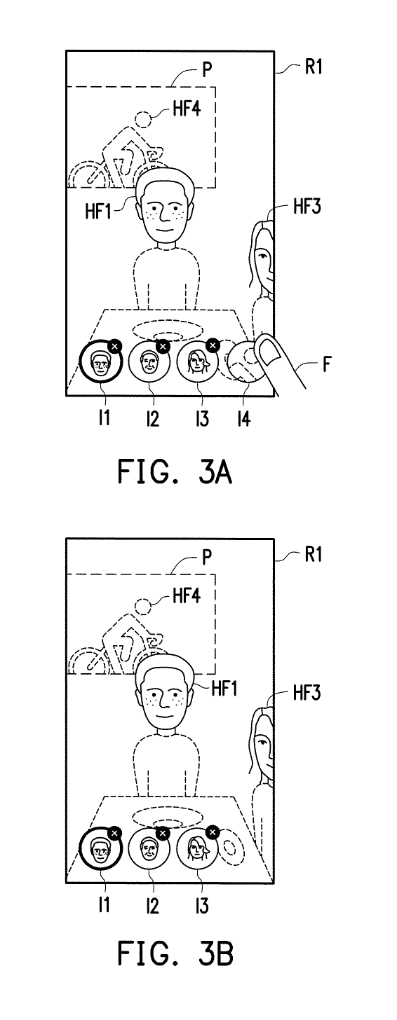

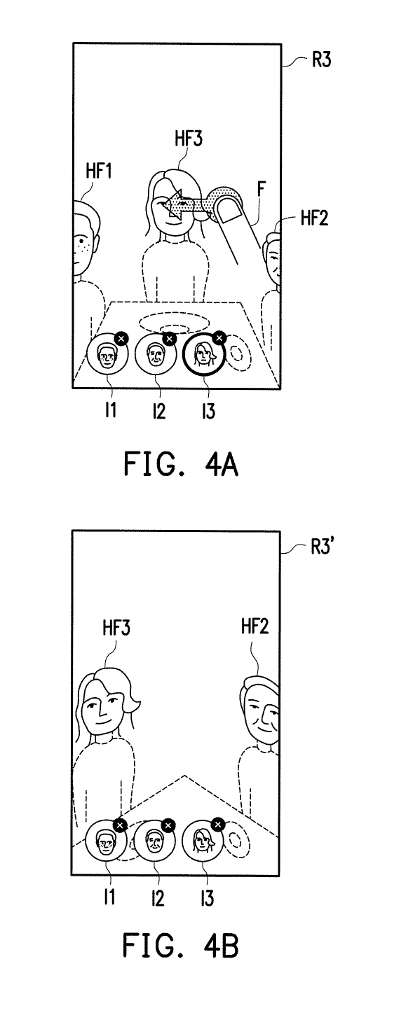

FIG. 3A-FIG. 3B as well as FIG. 4A-FIG. 4B illustrate different scenarios of displaying a panoramic image in accordance with one of exemplary embodiments of the disclosure.

In the present exemplary embodiment, assume that the screen 110 and the input device 115 would be integrated into a touch screen. When the user opens a panoramic image, a preset region R1 of the panoramic image and icons 11-14 would be displayed on the display frame as illustrated in FIG. 3A. The icons 11-14 are associated with key human faces HF1-HF4, where only the key human faces HF1, HF3, and HF4 are located in the preset region R1, and the key human face HF1 is at the center of the preset region R1. Since the key human face HF4 herein is actually a human face on a painting P but not a main subject of interests or intended to be captured, the processor 130 may allow the user to perform a deleting operation on the icons 11-14, and the user may then be able to delete any icon not corresponding to the main subjects. Assume that the user wishes to delete the icon 14. After the processor 130 detects a deleting operation performed by the user's finger on the icon 14, the icon 14 would be removed from the display frame as illustrated in FIG. 3B.

Next, assume that the user wishes to view the entire key human face HF3 corresponding to the icon I3. After the processor 130 detects a selecting operation performed by the user's finger on the icon I3, a region R3 of the panoramic image would be displayed on the display frame as illustrated in FIG. 4A, where the key human faces HF1, HF2, and HF3 are all located in the preset region R3, and the key human face HF3 is at the center of the region R3. Herein, the processor 130 may allow the user to perform a dragging operation on the display frame, and the user may then be able to manually adjust the display frame. Assume that the user wishes to view the entire key human face HF2. After the processor 130 detects a dragging operation performed by the user's finger F on the display frame, a region R3′ of the panoramic image would be displayed on the display frame as illustrated in FIG. 4B, where the key human face HF2 would be entirely displayed.

In an exemplary embodiment, the electronic device 100 would further include a communication device. The communication device would be configured to provide the electronic device 100 to be connected with other devices and may be an electronic component such as a wireless network communication chip or antenna with a WiMAX, Wi-Fi, 2G, 3G, 4G standard. The memory 130 would further store a contact list of the user, where the contact list would include contact persons as well as their images and information. The processor 130 would associate the key human faces with the images of the contact persons by leveraging human face recognition technology and transmit the panoramic image to the contact persons that are associated with the key human faces. Herein, the processor 130 may transmit the panoramic image according to the information of the contact persons (e.g. e-mail, text message, social media and instant message account) for real-time sharing.

In an exemplary embodiment, when different contact persons receive the panoramic image transmitted from the electronic device 100, different regions of the panoramic image would be presented on their electronic devices. Take FIG. 3B as an example. When the contact person associated with the key human face HF1 (referred to as “a first contact person”) opens the panoramic image on his/her electronic device, the region R1 would be displayed. That is, the face of the first contact person would be located at the center of the region R1. Take FIG. 4A as another example. When the contact person associated with the key human face HF3 (referred to as “a third contact person”) opens the panoramic image, the region R3 would be displayed. That is, the face of the third contact person would be located at the center of the region R3.

In view of the aforementioned descriptions, the method and the electronic device for displaying a panoramic image proposed in the disclosure would first identify key human faces from the panoramic image to display icons corresponding to the key human faces on the display frame, and then detect a selecting operation performed by the user on the icons to automatically shift the display frame to where the key human face corresponding to the selected icon is located. The disclosure would immediately guide the user about all key elements in a panoramic image so that the user would be able to view the panoramic image in an intuitive and speedy manner.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for displaying a panoramic image, applicable to an electronic device with a screen and an input device, wherein the method comprises steps of:
obtaining the panoramic image;
performing human face recognition on the panoramic image so as to identify a plurality of key human faces therefrom;
displaying a preset region of the panoramic image and a plurality of icons corresponding to the key human faces on a display frame of the screen; and
in response to a selecting operation performed by the user through the input device on a first icon among the icons being detected, displaying a first region, in which a first key human face corresponding to the first icon is located, on the display frame.

2. The method according to claim 1, wherein the step of performing human face recognition on the panoramic image so as to identify the key human faces therefrom comprises:
performing human face recognition on the panoramic image so as to identify a plurality of human faces therefrom; and
selecting the key human faces from the human faces according to a size of each of the human faces.

3. The method according to claim 1, wherein the step of performing human face recognition on the panoramic image so as to identify the key human faces therefrom comprises:
performing human face recognition on the panoramic image so as to identify a plurality of human faces therefrom; and
selecting the key human faces from the human faces according to position information of each of the human faces.

4. The method according to claim 1, wherein after the step of performing human face recognition on the panoramic image so as to identify the key human faces therefrom, the method further comprises a step of:
in response to a deleting operation performed by the user through the input device on a second icon among the icons being detected, removing the second icon from the display frame.

5. The method according to claim 1 further comprising a step of:
in response to a dragging operation performed by the user through the input device on the display frame being detected, displaying another region of the panoramic image on the display frame according to the dragging operation.

6. The method according to claim 1, wherein the electronic device further stores a contact list comprising a plurality of contact persons, wherein each of the contact persons comprises a contact person image, and wherein the method further comprises steps of:
associating the key human faces with the contact persons by using the contact person images; and
transmitting the panoramic image to the contact persons associated with the key human faces.

7. The method according to claim 6, wherein the contact persons comprise a first contact person associated the first key human face, and wherein the step of transmitting the panoramic image to the contact persons associated with the key human faces further comprises a step of:
transmitting the panoramic image to the first contact person, wherein when the first contact person opens the received panoramic image by using a first electronic device, the first electronic device displays the first region of the panoramic image.

8. An electronic device comprising:
a screen, configured to provide a display frame;
an input device, configured to detect operations performed on the electronic device;
a memory configured to store data;
a processor, coupled to the screen, the input device, and the memory, and configured to:
obtain the panoramic image;
perform human face recognition on the panoramic image so as to identify a plurality of key human faces therefrom;
display a preset region of the panoramic image and a plurality of icons corresponding to the key human faces on the display frame of the screen; and
in response to a selecting operation performed by the user through the input device on a first icon among the icons being detected, display a first region, in which a first key human face corresponding to the first icon is located, on the display frame.

9. The electronic device according to claim 8, wherein in response to a deleting operation performed by the user through the input device on a second icon among the icons being detected, the processor is further configured to remove the second icon from the display frame, and wherein in response to a dragging operation performed by the user through the input device on the display frame being detected, the processor is further configured to display another region of the panoramic image on the display frame according to the dragging operation.

10. The electronic device according to claim 8, wherein the memory further stores a contact list comprising a plurality of contact persons, wherein each of the contact persons comprises a contact person image, and wherein the electronic device further comprises:
a communication device, coupled to the processor, wherein the processor is further configured to associate the key human faces with the contact persons by using the contact person images and transmit the panoramic image to the contact persons associated with the key human faces through the communication device.
